(19) United States
(12) Patent Application Publication
(10) Pub. No.: US 2013/0313171 A1
(43) Pub. Date: Nov. 28, 2013

(54) PORTABLE WATER FILTER

(71) Applicant: HUI-MIN Chang Kuo, (TW)

(72) Inventor: HUI-MIN Chang Kuo, (TW)

(21) Appl. No.: 13/481,839

(22) Filed: May 27, 2012

(51) Int. Cl. B01D 29/50; B01D 35/00

(52) U.S. Cl. 210/85

(57) ABSTRACT

A portable water filter is provided with a structural assembly including a base; an upright member on the base and including pairs of side holding members; a battery compartment on the base; ports on an edge of the base; a top plate on the upright member and including a top recess; a telescoping handle in the upright member and the recess; knobs on the top plate; and indicators on the top plate; a rechargeable battery in the battering compartment; a filter assembly including a pump electrically connected to the rechargeable battery and being in fluid communication with an inlet water line, and filters releasably mounted on the pairs of holding members wherein the most downstream filter is in fluid communication with an outlet water line; and a cover including a top opening, the cover being releasably put on the structural assembly with the handle exposed.

### BACKGROUND OF THE INVENTION

1. Field of the Invention

The invention relates to water purification devices and more particularly to a portable water filter.

2. Description of Related Art

A water filter removes impurities from water by means of a fine physical barrier, a chemical process or a biological process. Filters cleanse water to various extents for drinking water, aquariums, etc.

A conventional water filter comprises a container having a water reservoir compartment for storing untreated water and a pumping compartment besides the reservoir compartment, the water reservoir compartment having a bottom wall, an inlet for adding untreated water to the reservoir compartment and a water outlet passage in the bottom wall, a pump mounted in the pumping compartment and having an inlet connected to the water outlet passage for receiving water from the reservoir compartment, and a filter releasably mounted in the water compartment and having an inlet connected to an outlet of the pump and an outlet nozzle integrally formed in the filter extending over an upper edge of the container.

However, as far as the present inventor is aware, there is no prior disclosure about a portable water filter discussed below and the water filter is neither taught nor rendered obvious thereby.

### SUMMARY OF THE INVENTION

It is therefore one object of the invention to provide a portable water filter comprising a structural assembly comprising a base; an upright member disposed on the base and including a plurality of pairs of holding members on both sides; a battery compartment disposed on the base and being adjacent to the upright member; a plurality of ports mounted on an edge of the base; a top plate formed on the upright member and including a top recess; a telescoping handle disposed in both the upright member and the recess; a plurality of knobs on a top of the top plate; and a plurality of indicators disposed on the top plate; a rechargeable battery disposed in the battering compartment; a filter assembly comprising a pump electrically connected to the rechargeable battery and being in fluid communication with an inlet water line, a plurality of filters each releasably mounted on the pair of holding members, and a plurality of lines for serially connecting the pump and the filters together wherein the most downstream filter is in fluid communication with an outlet water line; and a cover comprising a top opening, the cover being releasably put on the structural assembly with the handle being exposed; whereby the pump activates to draw untreated water from the inlet water line through the filters for purification and pump the filtered water out of the outlet water line.

The above and other objects, features and advantages of the invention will become apparent from the following detailed description taken with the accompanying drawings.

### BRIEF DESCRIPTION OF THE DRAWINGS

FIG. 1 is an exploded view of a portable water filter according to the invention;

FIG. 2 is a view similar to FIG. 1 but viewing from an opposite direction;

FIG. 3 is a perspective view of the assembled water filter;

FIG. 4 is a perspective view of the filter assembly;

FIG. 5 is an environmental view of the water filter being charged from a wall outlet;

FIG. 6 is another environmental view of the water filter being charged by a cigarette lighter receptacle;

FIG. 7 is an exploded view of the water filter showing a solar panel in another preferred embodiment of the invention;

FIG. 8 is a perspective view of the water filter with the telescopic handle being pulled out of top of the water filter; and

FIG. 9 is a view similar to FIG. 8 showing the handle being grasped by the hand for carrying purpose.

### DETAILED DESCRIPTION OF THE INVENTION

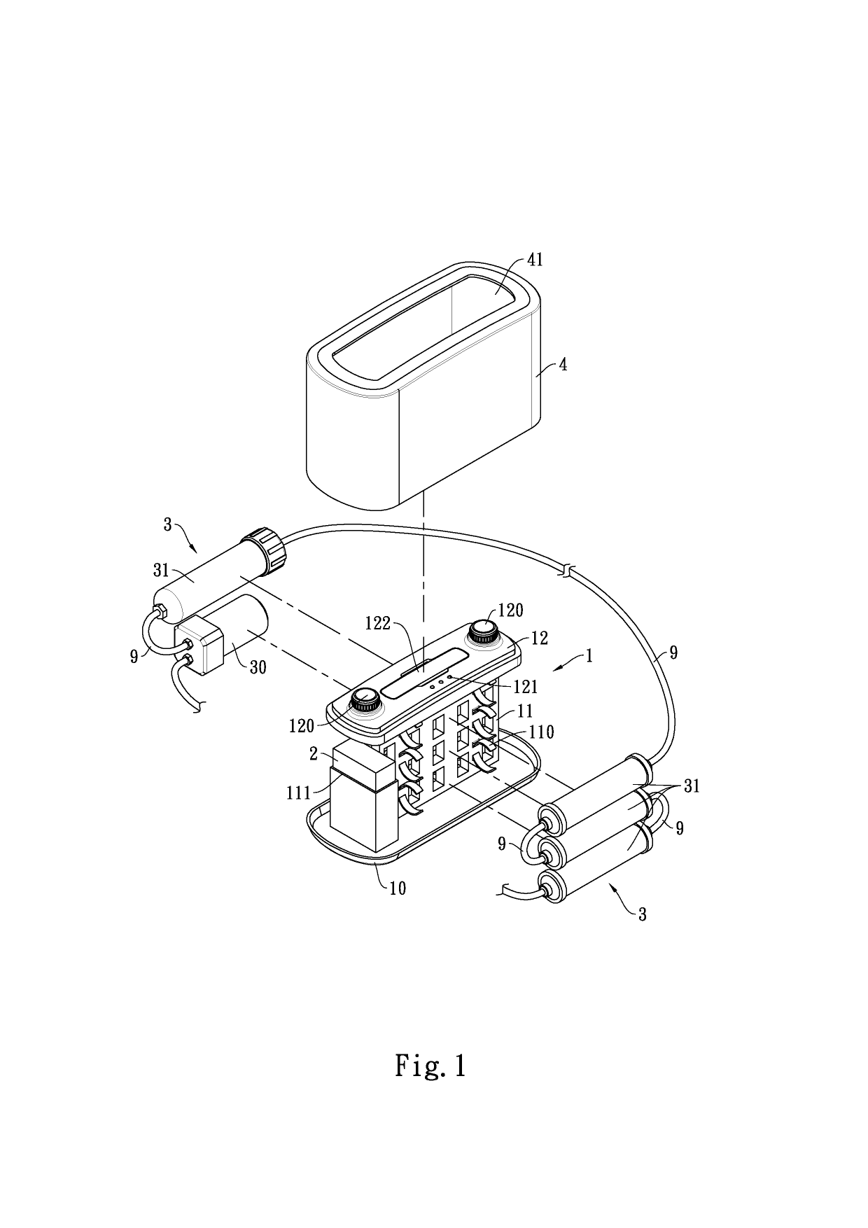

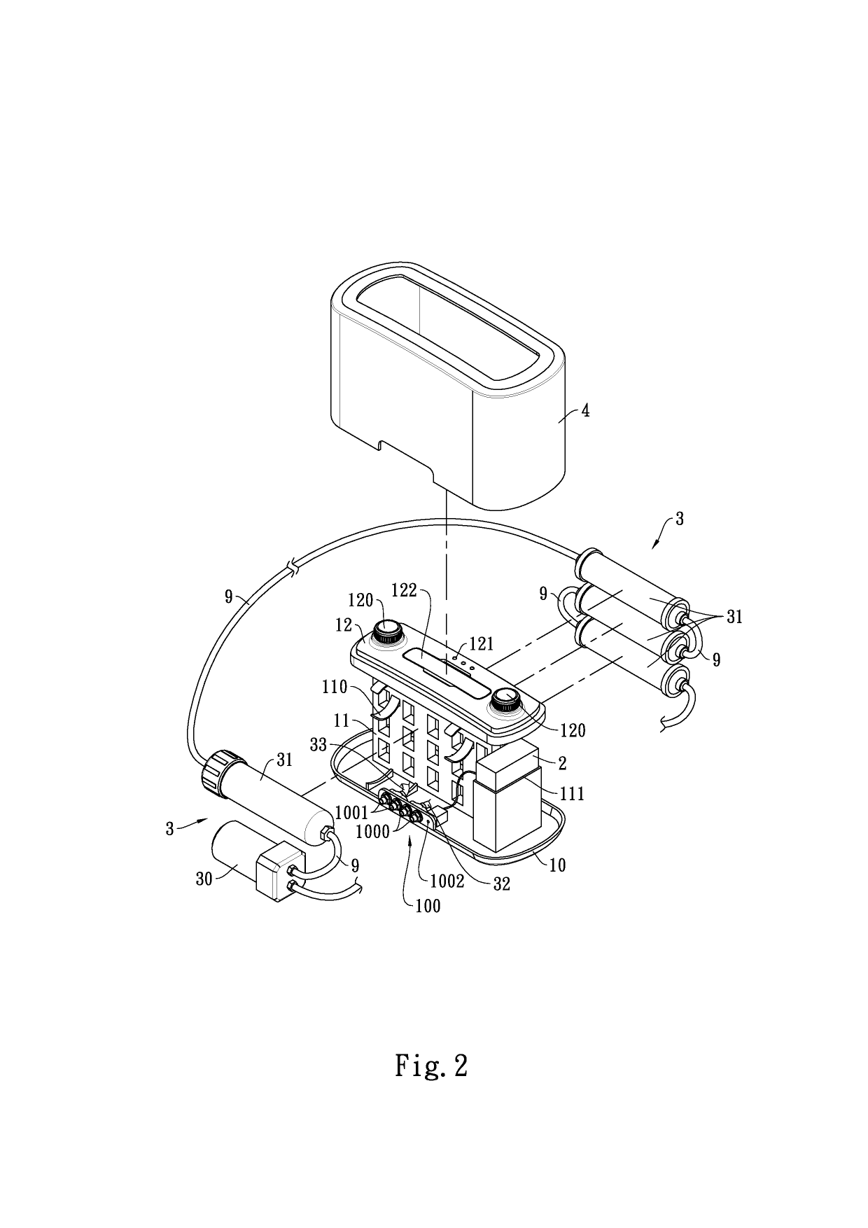

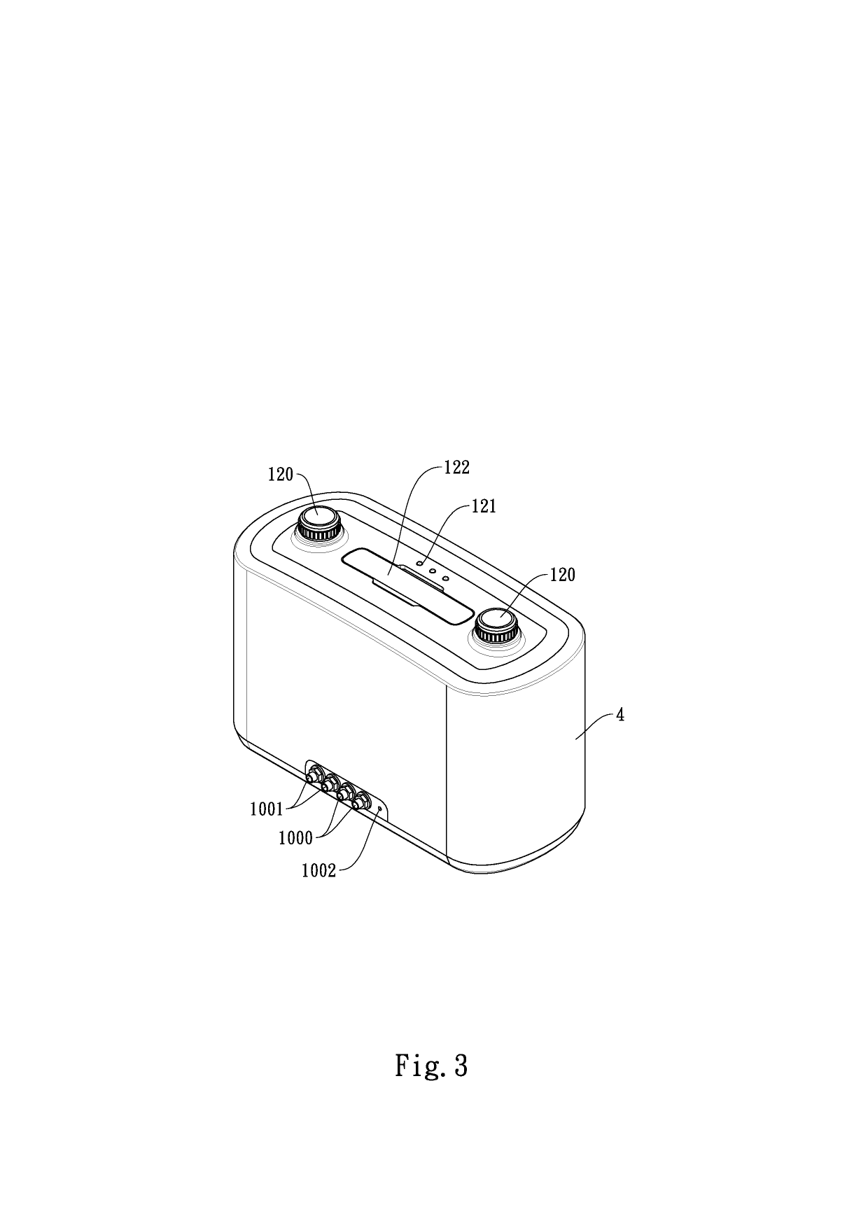

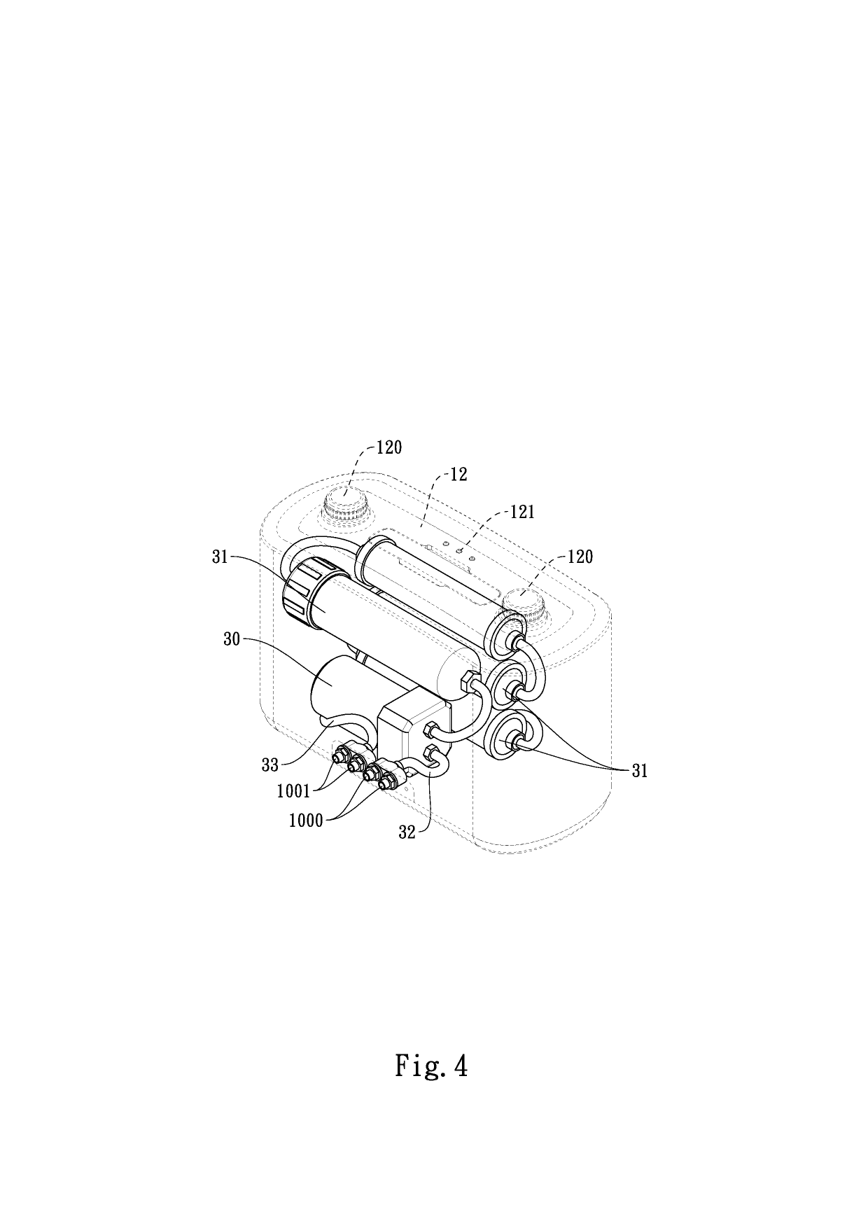

Referring to FIGS. 1 to 9, a portable water filter in accordance with the invention comprises the following components as discussed in detail below.

A structural assembly 1 comprises an oval base 10; a rectangular upright member 11 on a central portion of top of the base 10 and including a plurality of pairs of holding members 1120 on both sides, and a central top recess 112; a battery compartment 111 besides the upright member 11 and adjacent to one end of the base 10, the battering compartment 111 being adapted to store a rechargeable battery 2 therein; a series of ports 100 mounted on an edge of the base 10 and including two inlets 1000 connected to an inlet water line 32, two outlets 1001 connected to an outlet water line 33, and a charging socket 1002 electrically connected to the battery 2; an oval top plate 12 including two top knobs 120 adjacent to both ends respectively, a telescoping handle 122 disposed in both the upright member 11 and the recess 112 wherein the handle 122 is rested upon the recess 112 in a non-carrying position; and a plurality of indicators 121 between the recess 112 and one side of the top plate 12.

A filter assembly 3 comprises a motor driven pump 30 electrically connected to the battery 2 and being in fluid communication with the inlet water line 32, a plurality of filters 31 each releasably mounted on a pair of holding members 110, and a plurality of lines 9 for serially connecting the pump 30 and the filters 31 together. The most downstream filter 31 is in fluid communication with the outlet water line 33. A cover 4 has an oval top opening 41 and an open bottom, the cover 4 being shaped to put on the structural assembly 1 with its top rested upon the edge of the top plate 11 to expose the handle 122, the knobs 120, and the indicators 121, and its bottom edge rested upon the edge of the base 10 to assemble a complete water filter.

A user may manipulate one of the knobs 120 (i.e., being as an on/off switch) to electrically interconnect the pump 30 and the battery 2 so that the pump 30 can activate to draw untreated water from the inlet water line 32 through the filters 31 for purification and pump the filtered water out of the outlets 1001 via the outlet water line 33. At the same time one of the indicators 121 is lit. An activation time of the pump 30 can be set by manipulating the other knob 120 and such setting can be shown in the other two indicators 121.

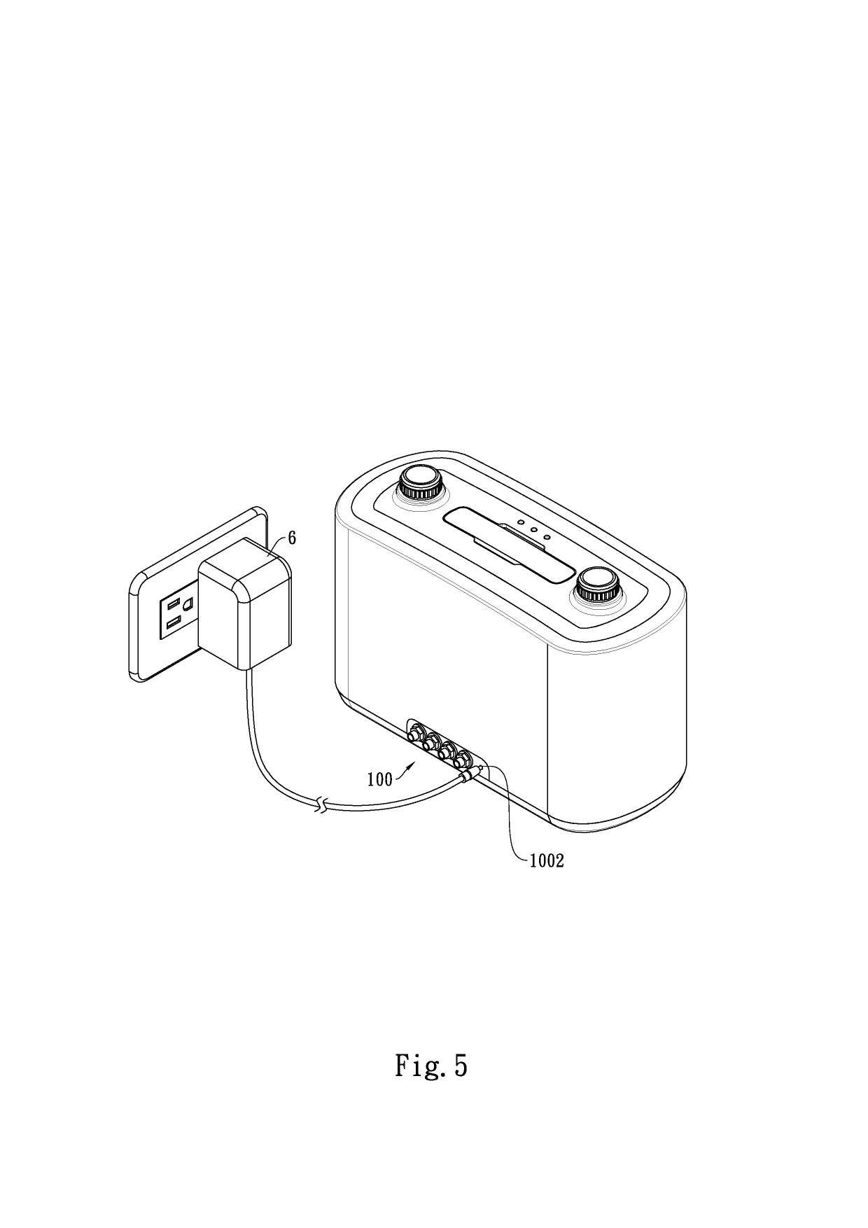

Referring to FIG. 5 specifically, in one configuration, an adapter 6 has one end inserted into a wall outlet and the other end inserted into the charging socket 1002 so that electricity can be supplied to the battery 2 for storage via the adapter 6.

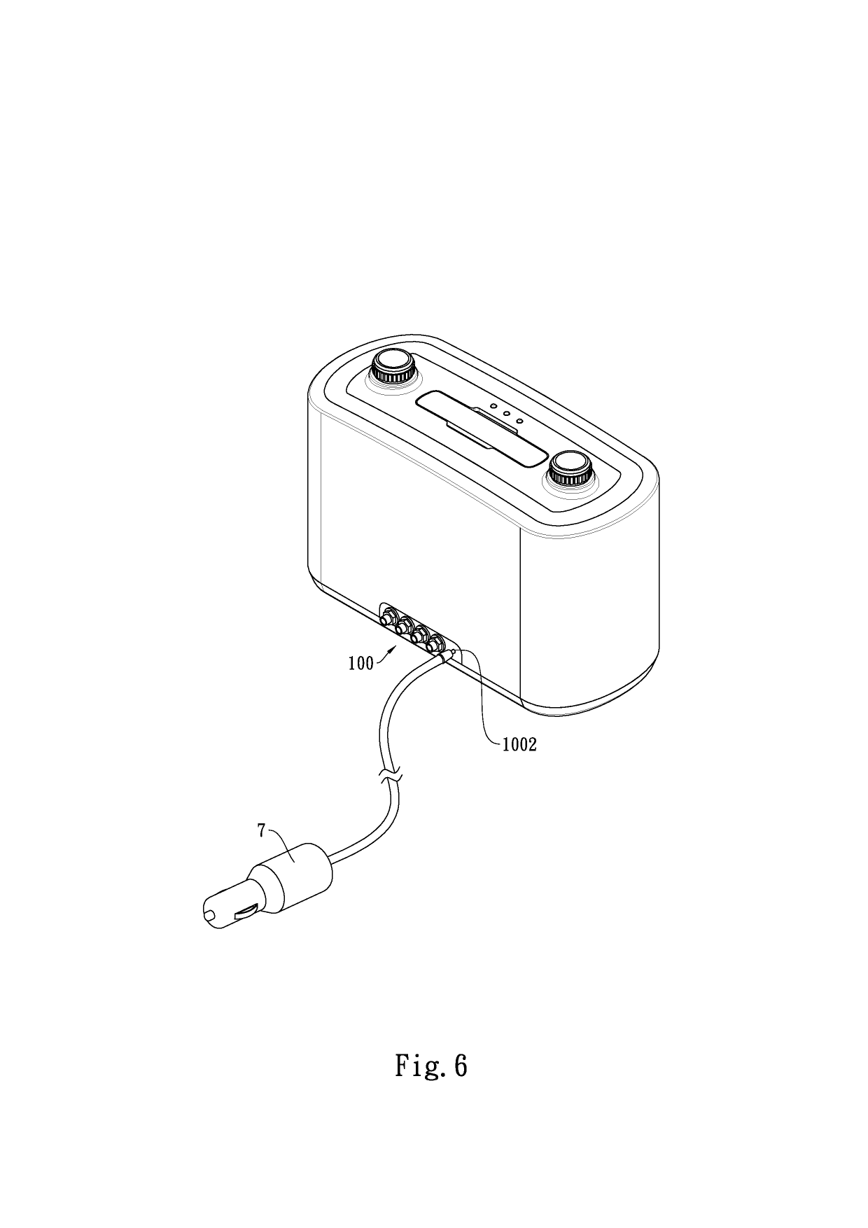

Referring to FIG. 6 specifically, in another configuration, a cigarette lighter receptacle 7 has a plug at one end of a wire inserted into the charging socket 1002 so that electricity can be supplied to the battery 2 for storage via the cigarette lighter receptacle 7.

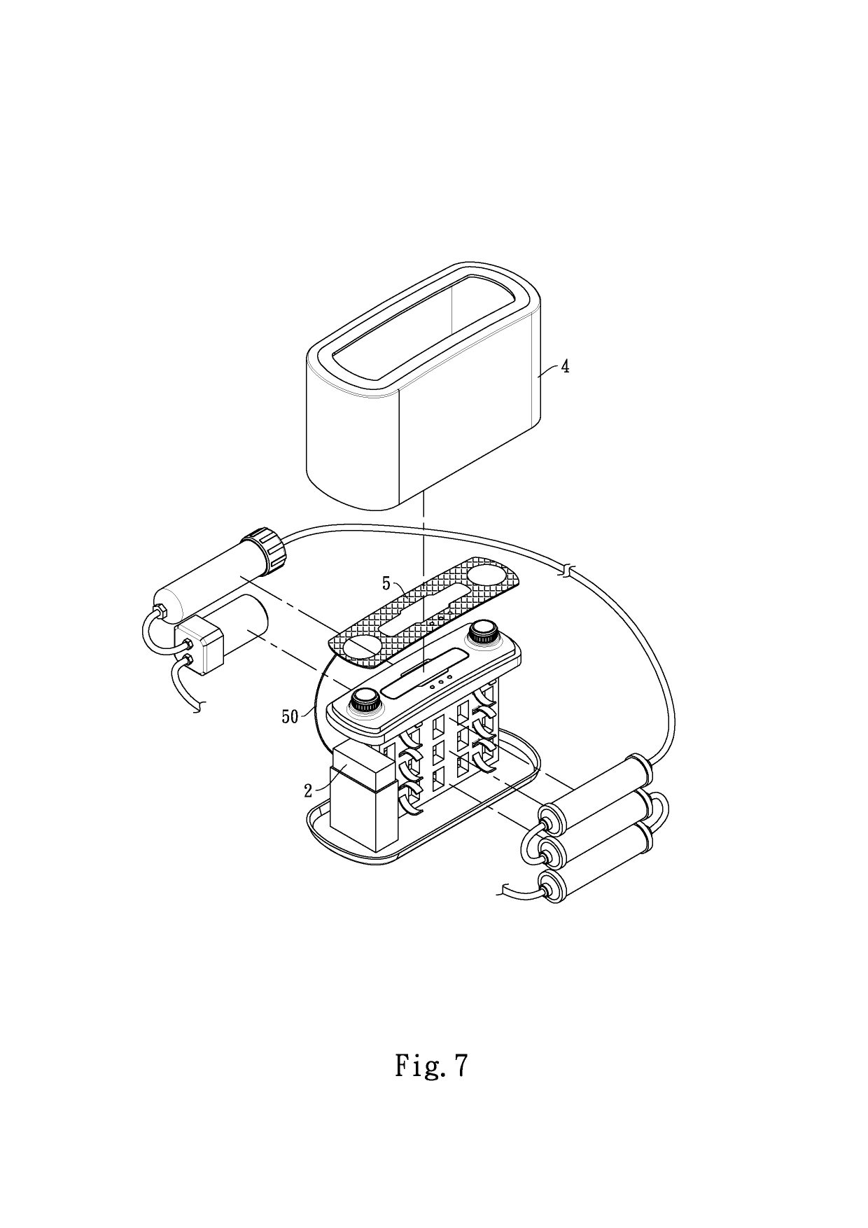

Referring to FIG. 7 specifically, in another preferred embodiment of the invention a solar panel 5 is rested upon the top of the top plate 12 with the knobs 120 and the handle 122 being exposed through the opening 41. The solar panel 5 is electrically connected to the battery 2 via an electrical line 50.

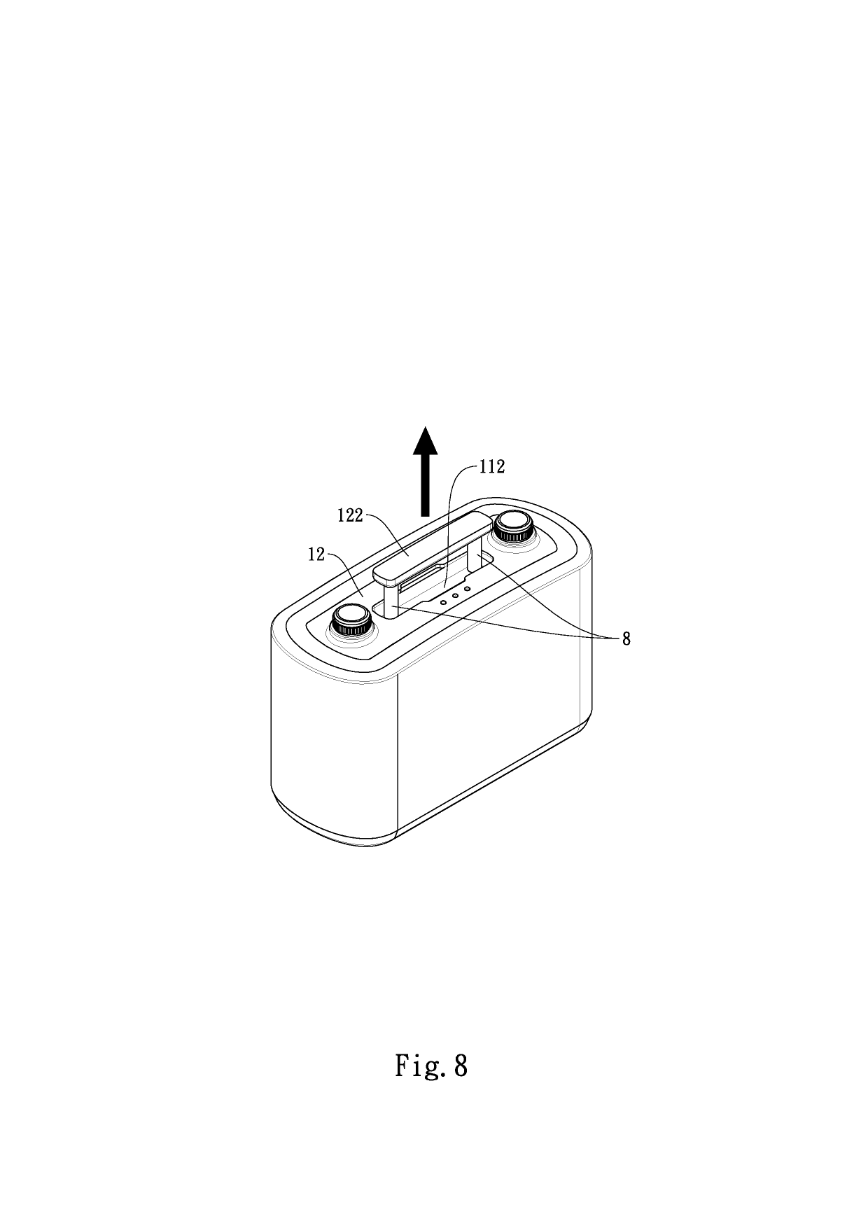

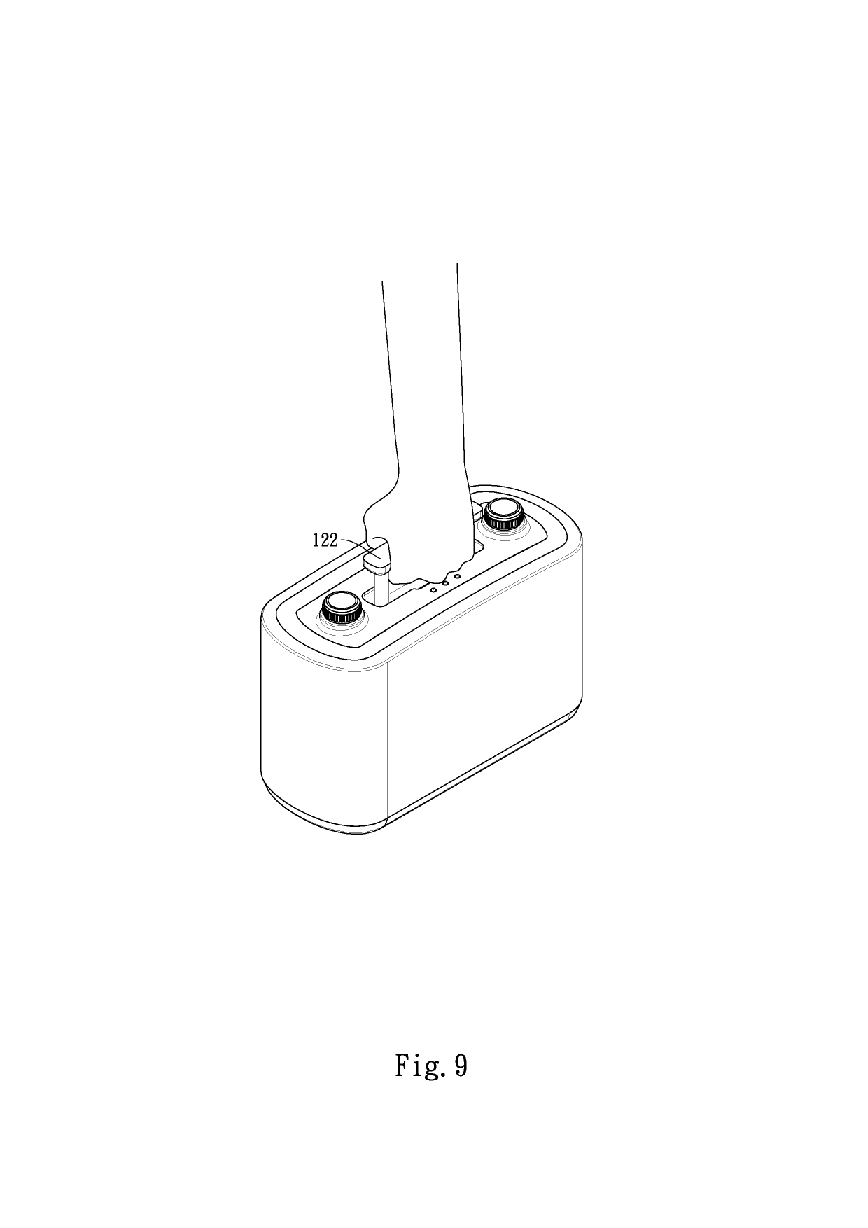

Referring to FIGS. 8 and 9 specifically, the handle 122 has two sliding tubes 8 extending downward from a bottom into the upright member 11. For carrying the water filter, a user may pull the handle 122 to its full prior to grasping the handle 122.

While the invention has been described in terms of preferred embodiments, those skilled in the art will recognize that the invention can be practiced with modifications within the spirit and scope of the appended claims.

What is claimed is:

1. A portable water filter comprising:
a structural assembly comprising a base; an upright member disposed on the base and including a plurality of pairs of holding members on both sides; a battery compartment disposed on the base and being adjacent to the upright member; a plurality of ports mounted on an edge of the base; a top plate formed on the upright member and including a top recess; a telescoping handle disposed in both the upright member and the recess; a plurality of knobs on a top of the top plate; and a plurality of indicators disposed on the top plate;
a rechargeable battery disposed in the battering compartment;
a filter assembly comprising a pump electrically connected to the rechargeable battery and being in fluid communication with an inlet water line, a plurality of filters each releasably mounted on the pair of holding members, and a plurality of lines for serially connecting the pump and the filters together wherein the most downstream filter is in fluid communication with an outlet water line; and
a cover comprising a top opening, the cover being releasably put on the structural assembly with the handle being exposed;
whereby the pump activates to draw untreated water from the inlet water line through the filters for purification and pump the filtered water out of the outlet water line.

2. The portable water filter of claim 1, wherein the ports comprise two inlets connected to the inlet water line, two outlets connected to the outlet water line, and a charging socket electrically connected to the rechargeable battery.

3. The portable water filter of claim 1, further comprising a solar panel disposed on the top plate, the solar panel being exposed through the top opening of the cover and electrically connected to the rechargeable battery.

4. The portable water filter of claim 1, further comprising a solar panel disposed on an outer surface of the cover, the solar panel being electrically connected to the rechargeable battery.

5. The portable water filter of claim 2, wherein the charging socket is adapted to electrically connect to an adapter.

6. The portable water filter of claim 2, wherein the charging socket is adapted to electrically connect to a cigarette lighter receptacle.

7. The portable water filter of claim 1, wherein the handle comprises two sliding tubes extending downward from a bottom into the upright member.
